(19) United States
(12) Patent Application Publication
(10) Pub. No.: US 2021/0114272 A1
(43) Pub. Date: Apr. 22, 2021

(54) APPARATUS AND METHOD FOR CONTROLLING AN INJECTION CYCLE OF AN INJECTION MOLDING MACHINE

(71) Applicant: Niigon Machines Ltd., Vaughan (CA)

(72) Inventors: Carsten Link, Burlington (CA); Erik Strohm, Sigel, PA (US); Luke Osmokrovic, Toronto (CA); Andrew Serles, Toronto (CA)

(73) Assignee: Niigon Machines Ltd., Vaughan (CA)

(21) Appl. No.: 17/061,861

(22) Filed: Oct. 2, 2020

Related U.S. Application Data
(63) Continuation of application No. PCT/CA2019/050412, filed on Apr. 4, 2019.
(60) Provisional application No. 62/652,715, filed on Apr. 4, 2018.

(51) Int. Cl. B29C 45/50; B29C 45/62; B29C 45/60; B29C 45/77; B29C 45/80

(52) U.S. Cl. CPC B29C 45/5008; B29C 45/62; B29C 45/60; B29C 2945/76665; B29C 45/80; B29C 2945/76498; B29C 2945/76568; B29C 45/77

(57) ABSTRACT

A method for controlling an injection cycle of an injection molding machine incudes advancing an injection screw axially forward toward an injection nozzle from a shot-size position to an injection position to inject melt from a shot chamber into a hot runner of a mold and from the hot runner to fill cavities of the mold. Then the injection screw is retracted away from the nozzle, from the injection position to a decompression position axially rearward of the shot-size position, to relieve melt pressure in the hot runner. Then the screw is advanced toward the nozzle from the decompression position to an intermediate position axially intermediate the injection position and the shot-size position. The method then includes rotating the screw to re-fill the shot chamber with melt and urge the screw to retract from the intermediate position to the shot-size position.

This application is a continuation of International Application Serial No. PCT/2019/050412, filed Apr. 4, 2019, which claims the benefit of Provisional Application Ser. No. 62/652,715, filed Apr. 4, 2018, which is hereby incorporated herein by reference.

### FIELD

The specification generally relates to one or more apparatuses and methods associated with plasticizing and injecting mold material into a mold of an injection molding machine.

### BACKGROUND

E.P. Pat. No. 2,873,505 (Mitsuaki et al.) discloses an injection molding machine including a cylinder that heats a molding material, a nozzle that is disposed at a front end of the cylinder, an injection member that injects the molding material in the cylinder from the nozzle to a mold unit, a driving unit that operates the injection member in the cylinder, a moving unit that allows the nozzle to advance and retract to the mold unit, and a controller that controls the driving unit and the moving unit, in which the controller performs at least a part of a first pressure reduction process in which a hot runner is reduced in pressure by the retraction of the nozzle to the mold unit and at least a part of a second pressure reduction process in which the hot runner is reduced in pressure by the operation of the injection member at the same time after gate seal of the mold unit.

U.S. Pat. No. 5,002,717 (Taniguchi) discloses a method for controlling the injection of a molten resin through an in-line screw type injection molding machine. The molding machine is equipped with a check ring for permitting the injection of the molten resin by an advancement of the screw and also for preventing the molten resin from flowing backward. According to the method, the screw is rotated in the normal direction to knead and plasticize a resin material and further to feed the resultant molten resin to the free end portion of the screw. The screw then retracts to meter and store a predetermined quantity of the molten resin adjacent to the free end portion of the screw. The screw is next rotated in the reverse direction to pressure of the molten resin on the rear side of the check ring lower than that of the molten resin thus metered and stored on the front side of the check ring. The screw retracts to reduce the pressure of the resin on the front side of the check ring, thereby performing a decompression stroke. The screw finally advances to inject the molten resin into a mold.

U.S. Pat. No. 6,340,439 (Hiraoka) discloses a motor-driven injection molding machine comprising an injection device which includes a heating cylinder for heating resin powder therein to melt the resin powder into molten resin and a screw disposed in the heading cylinder for feeding the molten resin in the heating cylinder forward to meter the molten resin. A controller positions, in response to a position detected signal detected by a position detector, the screw at a metering position using an injection servomotor on and immediately after completion of the plasticization and metering process. In addition, the controller rotates, in response to a pressure detected signal detected by a load cell, the screw in the opposite direction using a screw-rotation servomotor on and immediately after the completion of said plasticization and metering process to carry out depressurization of the molten resin in the heating cylinder that is metered ahead of the screw.

### SUMMARY

The following summary is intended to introduce the reader to various aspects of the applicant's teaching, but not to define any invention.

According to some aspects, a method for controlling an injection cycle of an injection molding machine includes: (a) advancing an injection screw axially forward toward an injection nozzle to inject melt from a shot chamber into a hot runner of a mold. The advancing step includes advancing the screw from a shot-size position to an injection position to fill cavities of the mold. The method further includes (b) after step (a), retracting the injection screw away from the nozzle, from the injection position to a decompression position axially rearward of the shot-size position, to relieve melt pressure in the hot runner; (c) after step (b), advancing the screw toward the nozzle from the decompression position to an intermediate position axially intermediate the injection position and the shot-size position; and (d) after step (c), rotating the screw to re-fill the shot chamber with melt and urge the screw to retract from the intermediate position to the shot-size position.

In some examples, the method further includes opening a nozzle shut-off valve prior to step (a) to provide fluid communication between the hot runner and the shot chamber through the nozzle during steps (a) and (b), and closing the nozzle shut-off valve after step (b) to inhibit fluid communication between the hot runner and the shot chamber through the nozzle during steps (c) and (d).

In some examples, the screw is housed in a barrel and the nozzle is at a front of the barrel, and the method further includes urging the barrel axially forward to hold the nozzle in sealed engagement with a sprue bushing of the mold during steps (a) and (b).

In some examples, the nozzle is in engagement with and axially stationary relative to a sprue bushing of the mold during step (b).

In some examples, the nozzle is in engagement with and axially stationary relative to a sprue bushing of the mold during step (c).

In some examples, the method further includes, during step (b), sucking back melt from the hot runner and into the shot chamber to relieve melt pressure in the hot runner.

In some examples, the method further includes exerting a clamp load across the mold during step (a), and opening the mold to eject molded articles after step (b).

In some examples, the mold is opened and the molded articles are ejected prior to the screw reaching the shot-size position in step (d).

According to some aspects, an injection unit for an injection molding machine includes: (a) a barrel extending along a horizontal barrel axis; (b) a nozzle at a front end of the barrel for discharging melt from the barrel; (c) a screw mounted in the barrel, the screw rotatable about the barrel axis and translatable along the barrel axis toward and away from the nozzle; (d) a shot chamber axially intermediate the screw and the nozzle; (d) a drive assembly for driving rotation and translation of the screw; and (e) a controller configured to, for each injection cycle, operate the drive assembly to: (i) advance the screw axially forward toward the nozzle from a shot-size position to an injection position to inject melt from the shot chamber into a hot runner of a mold to fill mold cavities; (ii) after (i), retract the screw axially rearward away from the nozzle from the injection position to a decompression position to relieve melt pressure in the hot runner, the decompression position axially rearward of the shot-size position; (iii) after (ii), advance the screw toward the nozzle from the decompression position to an intermediate position, the intermediate position axially intermediate the injection position and the shot-size position; and (iv) after (iii), rotate the screw to re-fill the shot chamber with melt and accommodate retraction of the screw away from the nozzle from the intermediate position to the shot-size position.

In some examples, the injection unit further includes a nozzle shut-off valve movable between an open position for providing fluid communication between the hot runner and the shot chamber through the nozzle, and a closed position for inhibiting fluid communication between the hot runner and the shot chamber through the nozzle. In some examples, the controller is configured to operate the nozzle shut-off valve to, for each injection cycle: move the nozzle shut-off valve to the open position prior to advancing the screw to the injection position; and move the nozzle shut-off valve to the closed position after the screw reaches the decompression position and prior to advancing the screw to the intermediate position.

In some examples, an injection molding machine includes: (a) a machine base extending along a horizontal machine axis, (b) a first platen supported by the machine base for carrying a first mold section of a mold; and (c) a second platen supported by the machine base for carrying a second mold section of the mold. The second platen is translatable along the machine axis toward and away from the first platen to close and open the mold. The mold includes a plurality of mold cavities and a hot runner for conducting melt to the mold cavities. The machine further includes (d) an injection unit supported by the base for injecting melt into the mold. The injection unit includes: a barrel extending along a horizontal barrel axis; a nozzle at a front end of the barrel for discharging melt from the barrel; a screw mounted in the barrel, the screw rotatable about the barrel axis and translatable along the barrel axis toward and away from the nozzle; a shot chamber axially intermediate the screw and the nozzle; a drive assembly for driving rotation and translation of the screw; and a controller configured to, for each injection cycle, operate the drive assembly to: (i) advance the screw axially forward toward the nozzle from a shot-size position to an injection position to inject melt from the shot chamber into the hot runner to fill the mold cavities; (ii) after (i), retract the screw axially rearward away from the nozzle from the injection position to a decompression position to relieve melt pressure in the hot runner, the decompression position axially rearward of the shot-size position; (iii) after (ii), advance the screw toward the nozzle from the decompression position to an intermediate position, the intermediate position axially intermediate the injection position and the shot-size position; and (iv) after (iii), rotate the screw to re-fill the shot chamber with melt and accommodate retraction of the screw away from the nozzle from the intermediate position to the shot-size position.

In some examples, the machine further includes a nozzle shut-off valve movable between an open position for providing fluid communication between the hot runner and the shot chamber through the nozzle, and a closed position for inhibiting fluid communication between the hot runner and the shot chamber through the nozzle. In some examples, the controller is configured to operate the nozzle shut-off valve to, for each injection cycle: move the nozzle shut-off valve to the open position prior to advancing the screw to the injection position; and move the nozzle shut-off valve to the closed position after the screw reaches the decompression position and prior to advancing the screw to the intermediate position.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic elevation view of an example injection molding machine;

FIG. 2 is a schematic cross-sectional view of portions of a mold and an injection unit of the machine of FIG. 1, with the mold shown in a closed condition, an injection screw of the injection unit shown in a shot-size position, and a valve of the injection unit shown in an open position;

FIG. 3 is a schematic cross-sectional view like that of FIG. 2, but with the screw shown in an injection position;

FIG. 4 is a schematic cross-sectional view like that of FIG. 3, but with the screw shown in a decompression position;

FIG. 5 is a schematic cross-sectional view like that of FIG. 4, but with the valve shown in the closed position;

FIG. 6 is a schematic cross-sectional view like that of FIG. 5, but with the mold shown in an open condition and the screw shown in an intermediate position;

FIG. 7 is a schematic cross-sectional view like that of FIG. 6, but with the mold shown in an ejection condition and the screw shown in another intermediate position; and

FIG. 8 is a schematic cross-sectional view like that of FIG. 7, but with the mold shown in the closed condition and the screw shown in the shot-size position; and

FIG. 9 is a flow chart showing an example method of controlling an injection cycle of the machine of FIG. 1.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

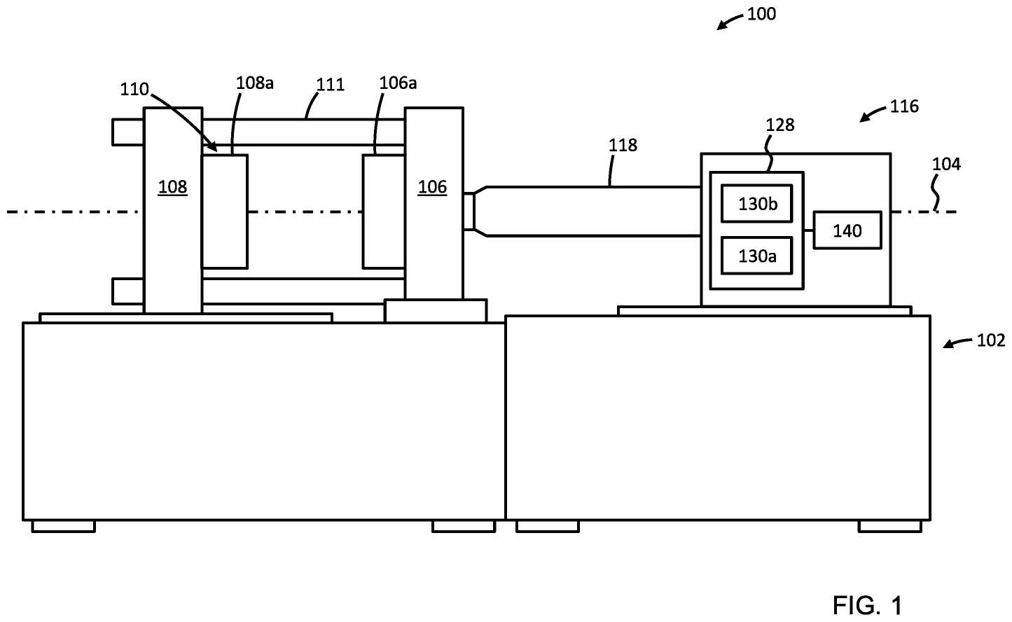

Referring to FIG. 1, in the example illustrated, an injection molding machine 100 includes a machine base 102 extending along a horizontal machine axis 104. A first platen 106 is supported by the machine base 102 for carrying a first mold section 106a of a mold 110, and a second platen 108 is supported by the machine base 102 for carrying a second mold section 108a of the mold 110. The second platen 108 is translatable along the machine axis 104 toward and away from the first platen 106 to close and open the mold 110. In the example illustrated, a plurality of tie bars 111 extend between the first and second platens 106, 108 for coupling the platens 106, 108 together and exerting a clamp load across the mold 110 when stretched.

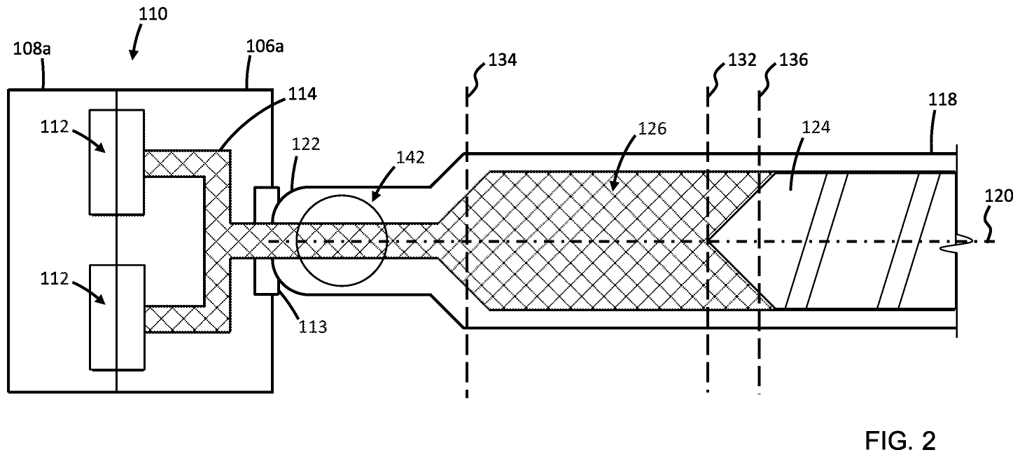

In the example illustrated, the machine 100 further includes an injection unit 116 supported by the base 102 for plasticizing and injecting resin or other mold material (also referred to as “melt”) into the mold 110. Referring to FIG. 2, in the example illustrated, the injection unit 116 includes a barrel 118 extending along a barrel axis 120, a nozzle 122 at a front end of the barrel 118 for discharging melt from the barrel 118, a screw 124 mounted in the barrel 118, and a shot chamber 126 in the barrel 118 axially intermediate the screw 124 and the nozzle 122 for holding melt. In the example illustrated, the mold 110 includes a plurality of mold cavities 112, a sprue bushing 113 in sealed engagement with the nozzle 122 for receiving melt, and a hot runner 114 for conducting the melt from the sprue busing 113 to the mold cavities 112.

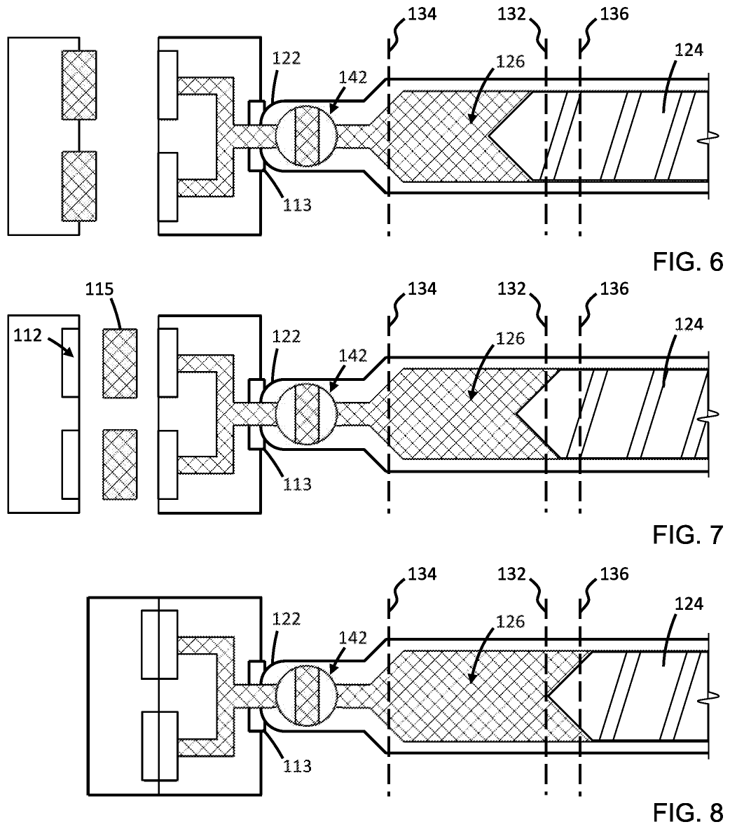

In the example illustrated, the screw 124 is rotatable about the barrel axis 120 for plasticizing resin or other mold material and filling the shot chamber 126 with melt. In the example illustrated, the screw 124 is translatable along the barrel axis 120 toward and away from the nozzle 122 to alternately load the shot chamber with melt and to inject the melt into the hot runner 114 to fill the mold cavities 112 and form molded articles 115 (FIG. 7). Referring to FIG. 1, in the example illustrated, the injection unit 116 includes a drive assembly 128 for driving rotation and translation of the screw 124. In the example illustrated, the drive assembly 128 includes a linear actuator 130a, for example a hydraulic cylinder, for driving translation of the screw 124, and one or more servomotors 130b for driving rotation of the screw 124.

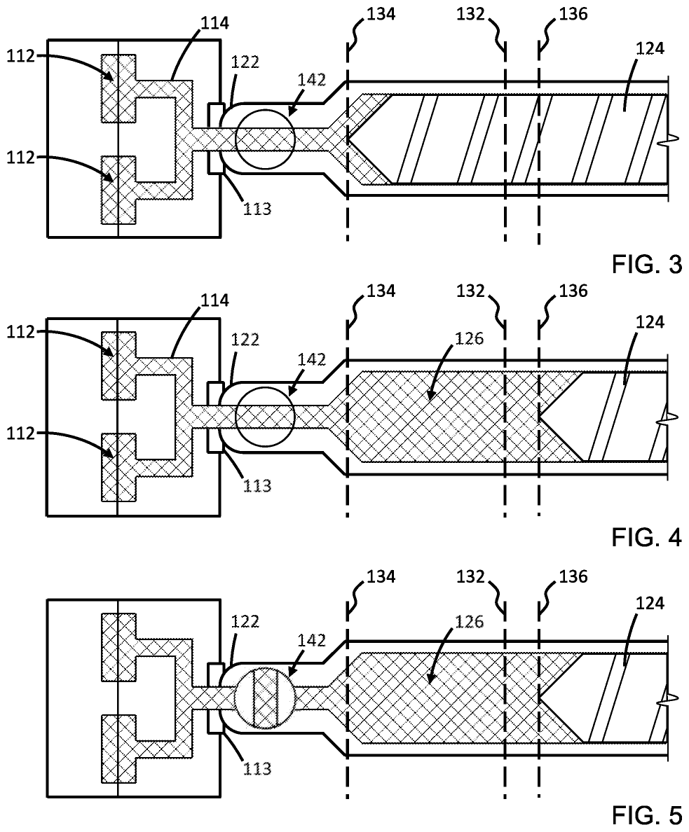

Referring still to FIG. 1, in the example illustrated, the machine 100 includes a controller 140 for controlling operation of the injection unit 116. The controller 140 can include, for example, at least one computer processor, and one or more communication interfaces for providing communication between the processor and other system components. In the example illustrated, the controller 140 is configured for controlling translation of the injection screw 124 to facilitate decompression of the hot runner 114 and help inhibit leakage of melt when the mold 110 is opened. In the example illustrated, the controller 140 is configured to, for each injection cycle, operate the drive assembly 128 to translate the screw 124 among a shot-size position 132 (FIG. 2), an injection position 134 (FIG. 3) axially forward of the shot-size position 132, a decompression position 136 (FIG. 4) axially rearward of the shot-size position 132, and an intermediate position (FIG. 6) axially intermediate the shot-size position 132 and the injection position 134.

Referring to FIG. 2, in the example illustrated, when the screw 124 is in the shot-size position 132, the shot chamber 126 has a shot volume sized to hold a shot of melt for injection into the hot runner 114 to fill the mold cavities 112. Referring to FIG. 3, in the example illustrated, the controller 140 is configured to operate the drive assembly 128 to advance the screw 124 axially forward toward the nozzle 122 from the shot-size position 132 to the injection position 134 to inject melt from the shot chamber 126 into the hot runner 114 to fill the mold cavities 112.

Referring to FIG. 4, in the example illustrated, the controller 140 is further configured to operate the drive assembly 128 to, after the mold cavities 112 are filled, retract the screw 124 axially rearward from the injection position 134 to the decompression position 136. Retracting the screw 124 to a position intermediate the injection position and the shot size position is normally done to relieve melt pressure in the hot runner 114. According to the present invention, because the decompression position is axially rearward of the shot-size position, the shot chamber 126 is quickly expanded to a volume beyond the shot volume which can facilitate improved suck back of melt from the hot runner 114 into the shot chamber 126. In this way, rapid decompression of the hot runner 114 can be achieved, helping to minimize or eliminate drooling of melt from the hot runner 114 onto a front surface of the mold half 106a when the mold is open.

Referring to FIG. 6, in the example illustrated, the controller 140 is further configured to operate the drive assembly 128 to, after the melt pressure is relieved, advance the screw 124 toward the nozzle 122 from the decompression position 136 to the intermediate position (shown in FIG. 6). Referring to FIGS. 7 and 8, in the example illustrated, the controller 140 is further configured to operate the drive assembly 128 to, after the screw 124 reaches the intermediate position, rotate the screw 124 to re-fill the shot chamber 126 with melt and accommodate retraction of the screw 124 away from the nozzle 122 from the intermediate position to the shot-size position 132 for a subsequent injection cycle. As the screw rotates to plasticize melt, the melt is forced forward into the shot chamber 126, which in turn urges the screw rearward, towards the shot size position. The controller 140 can be configured to operate the drive assembly to 128 exert a forward-acting force on the screw 124 during this process to hold the front of the screw 124 against the rearwardly advancing melt front, and the controller 140 can operate the drive assembly 128 to stop motion of the screw 124 when the screw 124 has reached the shot size position 132. This can facilitate accurate metering of melt into the shot chamber 126 for a subsequent injection cycle.

Referring to FIG. 2, in the example illustrated, the machine 100 further includes a nozzle shut-off valve 142 movable between an open position (shown in FIG. 2) for providing fluid communication between the hot runner 114 and the shot chamber 126 through the nozzle 122, and a closed position (shown in FIG. 5) for inhibiting fluid communication between the hot runner 114 and the shot chamber 126 through the nozzle 122. In the example illustrated, the nozzle shut-off valve 142 comprises a rotary valve.

Referring to FIGS. 2 and 3, in the example illustrated, the controller 140 is configured to operate the nozzle shut-off valve 142 to, for each injection cycle, move the nozzle shut-off valve 142 to the open position prior to advancing the screw 124 from the shot-size position 132 to the injection position 134. Referring to FIGS. 4 and 5, in the example illustrated, the controller 140 is further configured to operate the nozzle shut-off valve 142 to, for each injection cycle, move the nozzle shut-off valve 142 to the closed position after the screw 124 reaches the decompression position 136 and prior to advancing the screw 124 to the intermediate position.

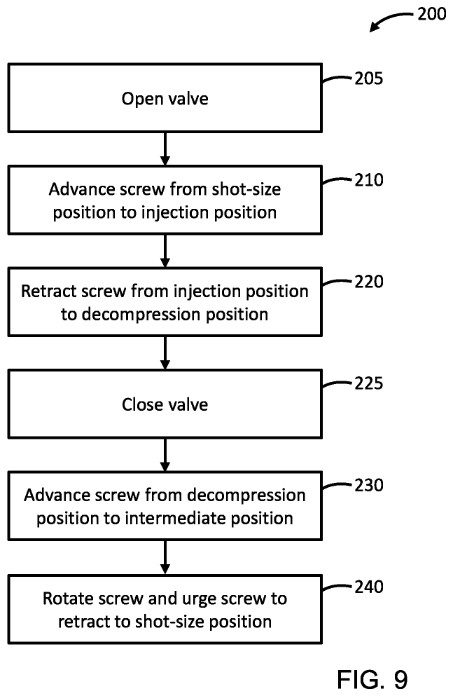

Referring to FIG. 9, a method 200 for controlling an injection cycle of the machine 100 will now be described. At step 205, the nozzle shut-off valve 142 is opened to provide fluid communication between the hot runner 114 and the shot chamber 126 through the nozzle 122 (see FIG. 2).

At step 210, the injection screw 124 is advanced axially forward toward the injection nozzle 122 to inject melt from the shot chamber 126 into the hot runner 114. Step 210 includes advancing the screw 124 from the shot-size position 132 to the injection position 134 to fill the mold cavities 112 (see FIGS. 2 and 3). In the example illustrated, a clamp load is exerted across the mold 110 during step 210.

At step 220, the injection screw 124 is retracted away from the nozzle 122, from the injection position 134 to the decompression position 136, to relieve melt pressure in the hot runner 114 (see FIG. 4). In the example illustrated, during step 220, the nozzle shut-off valve 142 remains open, and melt is sucked back from the hot runner 114 into the shot chamber 126 to relieve melt pressure in the hot runner 114.

In the example illustrated, during steps 210 and 220, the barrel 118 is urged axially forward to hold the nozzle 122 in sealed engagement with the sprue bushing 113 of the mold 110. In the example illustrated, the nozzle 122 is in engagement with and axially stationary relative to the sprue bushing 113 during steps 210 and 220.

At step 225, the nozzle shut-off valve 142 is closed to inhibit fluid communication between the hot runner 114 and the shot chamber 126 through the nozzle 122.

At step 230, the screw 124 is advanced toward the nozzle 122 from the decompression position 136 to the intermediate position. In the example illustrated, the nozzle 122 is in engagement with and axially stationary relative to the sprue bushing 113 during step 230. At step 240, the screw 124 is rotated to re-fill the shot chamber 126 with melt and urged to retract from the intermediate position to the shot-size position 132 for a subsequent injection cycle. In the example illustrated, the screw is urged to retract to the shot-size position 132 via melt accumulating in the shot chamber 126. In the example illustrated, the nozzle shut-off valve 142 remains closed during steps 230 and 240.

In the example illustrated, after step 220, the mold 110 is opened to eject the molded articles 115. In the example illustrated, the mold 110 is opened and the molded articles 115 are ejected prior to the screw reaching the shot-size position in step 240.

One or more apparatuses, systems, and methods described herein may be implemented in hardware or software, or a combination of both. These examples may be implemented in, for example, computer programs executing on programmable computers, and each computer may include at least one processor, a data storage system (including volatile memory, non-volatile memory, other data storage elements, and/or a combination thereof), and one more communication interfaces.

1. A method for controlling an injection cycle of an injection molding machine, comprising:
(a) advancing an injection screw axially forward toward an injection nozzle to inject melt from a shot chamber into a hot runner of a mold, the advancing step including advancing the screw from a shot-size position to an injection position to fill cavities of the mold;
(b) after step (a), retracting the injection screw away from the nozzle, from the injection position to a decompression position axially rearward of the shot-size position, to relieve melt pressure in the hot runner;
(c) after step (b), advancing the screw toward the nozzle from the decompression position to an intermediate position axially intermediate the injection position and the shot-size position; and
(d) after step (c), rotating the screw to re-fill the shot chamber with melt and urge the screw to retract from the intermediate position to the shot-size position.

2. The method of claim 1, further comprising opening a nozzle shut-off valve prior to step (a) to provide fluid communication between the hot runner and the shot chamber through the nozzle during steps (a) and (b), and closing the nozzle shut-off valve after step (b) to inhibit fluid communication between the hot runner and the shot chamber through the nozzle during steps (c) and (d).

3. The method of claim 1, wherein the screw is housed in a barrel and the nozzle is at a front of the barrel, and the method further comprises urging the barrel axially forward to hold the nozzle in sealed engagement with a sprue bushing of the mold during steps (a) and (b).

4. The method of claim 1, wherein the nozzle is in engagement with and axially stationary relative to a sprue bushing of the mold during step (b).

5. The method of claim 1, wherein the nozzle is in engagement with and axially stationary relative to a sprue bushing of the mold during step (c).

6. The method of claim 1, further comprising, during step (b), sucking back melt from the hot runner and into the shot chamber to relieve melt pressure in the hot runner.

7. The method of claim 1, further comprising exerting a clamp load across the mold during step (a), and opening the mold to eject molded articles after step (b).

8. The method of claim 7, wherein the mold is opened and the molded articles are ejected prior to the crew reaching the shot size position in step (d).

9. An injection unit for an injection molding machine, comprising:
(a) a barrel extending along a horizontal barrel axis;
(b) a nozzle at a front end of the barrel for discharging melt from the barrel;
(c) a screw mounted in the barrel, the screw rotatable about the barrel axis and translatable along the barrel axis toward and away from the nozzle;
(d) a shot chamber axially intermediate the screw and the nozzle;
(d) a drive assembly for driving rotation and translation of the screw; and
(e) a controller configured to, for each injection cycle, operate the drive assembly to:
i) advance the screw axially forward toward the nozzle from a shot-size position to an injection position to inject melt from the shot chamber into a hot runner of a mold to fill mold cavities;
ii) after (i), retract the screw axially rearward away from the nozzle from the injection position to a decompression position to relieve melt pressure in the hot runner, the decompression position axially rearward of the shot-size position;
iii) after (ii), advance the screw toward the nozzle from the decompression position to an intermediate position, the intermediate position axially intermediate the injection position and the shot-size position; and
iv) after (iii), rotate the screw to re-fill the shot chamber with melt and accommodate retraction of the screw away from the nozzle from the intermediate position to the shot-size position.

10. The injection unit of claim 9, further comprising: a nozzle shut-off valve movable between an open position for providing fluid communication between the hot runner and the shot chamber through the nozzle, and a closed position for inhibiting fluid communication between the hot runner and the shot chamber through the nozzle, and wherein the controller is configured to operate the nozzle shut-off valve to, for each injection cycle: move the nozzle shut-off valve to the open position prior to advancing the screw to the injection position; and move the nozzle shut-off valve to the closed position after the screw reaches the decompression position and prior to advancing the screw to the intermediate position.

11. An injection molding machine, comprising:
(a) a machine base extending along a horizontal machine axis,
(b) a first platen supported by the machine base for carrying a first mold section of a mold;
(c) a second platen supported by the machine base for carrying a second mold section of the mold, the second platen translatable along the machine axis toward and away from the first platen to close and open the mold, the mold including a plurality of mold cavities and a hot runner for conducting melt to the mold cavities;
(d) an injection unit supported by the base for injecting melt into the mold cavities, the injection unit including: a barrel extending along a horizontal barrel axis; a nozzle at a front end of the barrel for discharging melt from the barrel; a screw mounted in the barrel, the screw rotatable about the barrel axis and translatable along the barrel axis toward and away from the nozzle; a shot chamber axially intermediate the screw and the nozzle; a drive assembly for driving rotation and translation of the screw; and a controller configured to, for each injection cycle, operate the drive assembly to:
i) advance the screw axially forward toward the nozzle from a shot-size position to an injection position to inject melt from the shot chamber into the hot runner to fill the mold cavities;
ii) after (i), retract the screw axially rearward away from the nozzle from the injection position to a decompression position to relieve melt pressure in the hot runner, the decompression position axially rearward of the shot-size position;
iii) after (ii), advance the screw toward the nozzle from the decompression position to an intermediate position, the intermediate position axially intermediate the injection position and the shot-size position; and
iv) after (iii), rotate the screw to re-fill the shot chamber with melt and accommodate retraction of the screw away from the nozzle from the intermediate position to the shot-size position.

12. The machine of claim 11, further comprising: a nozzle shut-off valve movable between an open position for providing fluid communication between the hot runner and the shot chamber through the nozzle, and a closed position for inhibiting fluid communication between the hot runner and the shot chamber through the nozzle, and wherein the controller is configured to operate the nozzle shut-off valve to, for each injection cycle: move the nozzle shut-off valve to the open position prior to advancing the screw to the injection position; and move the nozzle shut-off valve to the closed position after the screw reaches the decompression position and prior to advancing the screw to the intermediate position.
